(19) United States
(12) Patent Application Publication
(10) Pub. No.: US 2014/0350931 A1
(43) Pub. Date: Nov. 27, 2014

(54) LANGUAGE MODEL TRAINED USING PREDICTED QUERIES FROM STATISTICAL MACHINE TRANSLATION

(71) Applicant: Microsoft Corporation, Redmond, WA (US)

(72) Inventors: Michael Levit, San Jose, CA (US); Dilek Hakkani-Tur, Los Altos, CA (US); Gokhan Tur, Los Altos, CA (US)

(73) Assignee: Microsoft Corporation, Redmond, WA (US)

(21) Appl. No.: 13/902,470

(22) Filed: May 24, 2013

(51) Int. Cl. G10L 15/06

(52) U.S. Cl. CPC G10L 15/063
USPC 704/243

(57) ABSTRACT

A Statistical Machine Translation (SMT) model is trained using pairs of sentences that include content obtained from one or more content sources (e.g. feed(s)) with corresponding queries that have been used to access the content. A query click graph may be used to assist in determining candidate pairs for the SMT training data. All/portion of the candidate pairs may be used to train the SMT model. After training the SMT model using the SMT training data, the SMT model is applied to content to determine predicted queries that may be used to search for the content. The predicted queries are used to train a language model, such as a query language model. The query language model may be interpolated other language models, such as a background language model, as well as a feed language model trained using the content used in determining the predicted queries.

### BACKGROUND

There is an increasing demand to interact with computing devices using spoken language. There are many practical applications for using speech, including searching, command and control, spoken dialog systems, natural language understanding systems, and the like. For example, a user may utter a query to a search system to locate content. Theses spoken dialog systems use language models to assist in understanding the received spoken input. Training and adapting the language models may take a lot of time and manual effort. Even after spending the time and effort on training the language models, the language models may still not work well with some voice input.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A Statistical Machine Translation (SMT) model is trained using pairs of sentences that include content obtained from one or more content sources (e.g. feed(s)) with corresponding queries that have been used to access the content. A query click graph may be used to assist in determining candidate pairs for the SMT training data. All/portion of the candidate pairs may be used to train the SMT model. After training the SMT model using the SMT training data, the SMT model is applied to content to determine predicted queries that may be used to search for the content. The predicted queries are used to train a language model, such as a query language model. The query language model may be interpolated with other language models, such as a background language model, as well as a feed language model trained using the content used in determining the predicted queries.

### BRIEF DESCRIPTION OF THE DRAWINGS

FIG. 1 shows a system for training an SMT model that is used to predict queries used in training a language model;

FIG. 2 illustrates training an SMT model using pairs including a sentence from a content source and a query associated with the content source;

FIG. 3 illustrates using an SMT model to predict queries from received content used to train a language model;

FIG. 4 illustrates an overview process for training an SMT model and using the SMT model to predict queries used in training a language model from received content;

FIG. 5 illustrates an exemplary online system using a language model trained with predicted queries; and

FIGS. 6, 7A, 7B and 8 and the associated descriptions provide a discussion of a variety of operating environments in which embodiments of the invention may be practiced.

### DETAILED DESCRIPTION

Referring now to the drawings, in which like numerals represent like elements, various embodiment will be described elements, various embodiment will be described.

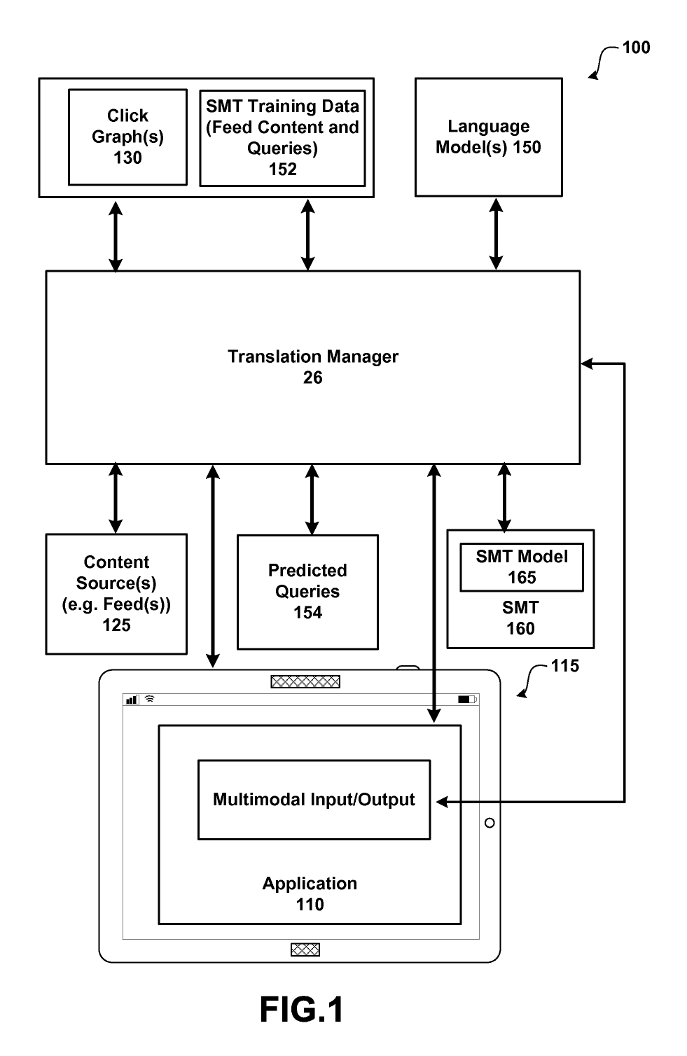

FIG. 1 shows a system for training an SMT model that is used to predict queries used in training a language model.

As illustrated, system 100 includes translation manager 26, content source(s) 125, click graph(s) 130, language model(s) 150, SMT training data 152, predicted queries 154, SMT 160 using SMT model 165, application 110 and touch screen input device 115.

In order to facilitate communication with the translation manager 26, one or more callback routines, may be implemented. According to one embodiment, application 110 is a multimodal application that is configured to receive speech input and obtain search results in response to the speech input. Application 110 may also receive input from a touch-sensitive input device 115 and/or other input devices. For example, voice input, keyboard input (e.g. a physical keyboard and/or SIP), video based input, and the like. Application program 110 may also provide multimodal output (e.g. speech, graphics, vibrations, sounds, . . . ). Translation manager 26 may provide information to/from application 110 in response to user input (e.g. speech/gesture). For example, a user may say a phrase to identify a task to perform by application 110 (e.g. performing a search, selecting content, buying an item, identifying a product, . . . ). Gestures may include, but are not limited to: a pinch gesture; a stretch gesture; a select gesture (e.g. a tap action on a displayed element); a select and hold gesture (e.g. a tap and hold gesture received on a displayed element); a swiping action and/or dragging action; and the like.

System 100 as illustrated comprises a touch screen input device 115 that detects when a touch input has been received (e.g. a finger touching or nearly teaching the touch screen).

Translation manager 26 may be used in training a Statistical Machine Translation (SMT) model using SMT training data 152. The trained SMT model (e.g. SMT model 165) may then be used to determine predicted queries 154 that are used in training a language model (e.g. language model(s) 150).

SMT training data may be obtained using different methods. Generally, SMT training data 152 includes pairs of sentences that include sentences obtained from a content source (e.g. content sources 125) that are matched with queries that were previously used to access content associated with each of the sentences.

Different methods may be used ways to obtain pairs of (natural language) sentences that represent a content source and search queries that are in reference to them. According to an embodiment, the seed content sources that are selected are web sites that include articles that a typical feed in the system would be derived from.

One or more click graph(s) 130 may be used to determine and collect the pairs used for the SMT training data 152. For example, the click graphs may be examined to determine seed web sites and determine queries that landed on these seed web sites to form a set of candidate pairings for the SMT training data 152. The set of candidate pairings may be examined to select pairings that are determined to be good representations. For example, a determination may be made as to how close a query and a feed sentence are in a vector-space model.

Once the SMT training data is determined, the SMT training data including the determined pairs is used to train SMT model 165. After training the SMT model, the SMT 160 is applied to new content to determine predicted queries 154. The predicted queries 154 are used to train one or more language models, such as a query language model. The language model trained using the predicted queries may be interpolated with other language modes, such as a background language model, as well as a language model trained using the feed content.

Translation manager 26 may be part of a dialog system that receives speech utterances and is configured to extract the meaning conveyed by a received utterance. More details are provided below.

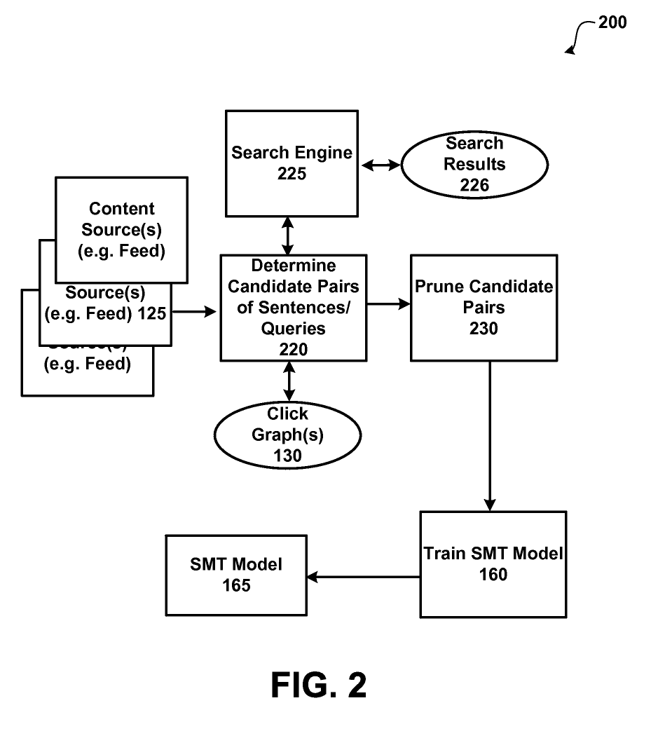

FIG. 2 illustrates training an SMT model using pairs including a sentence from a content source and a query associated with the content source. As illustrated, system 200 includes content source(s) 125, search engine 225, click graph(s) 130, search results 226, and SMT model 165.

One or more content sources 125 are selected as example “Seed” content sources that represent a “typical” content source/feed used within the system (e.g. a spoken dialog system). Depending on the application, different “seed” content source(s) may be selected. According to an embodiment, the seed content sources that are selected are web sites that include articles that a typical feed in the system would be derived from. Once the seed sites are selected, the candidate pairs are determined (220). A feed side for each of the pairs is determined and a query side for each of the pairs is determined According to an embodiment, the feed side of the pair is obtained from one or more of: a story title; one or more sentences from an article (e.g. the first sentences); and/or a summary of the article. For example, a summary including one or more sentences may be obtained from search results 226 as determined and delivered by a search engine, such as search engine 225.

One or more click graph(s) 130 may be used to determine and collect the pairs used for the SMT training data 152. For example, the click graphs may be examined to determine seed web sites and determine queries that landed on these seed web sites to form a set of candidate pairings for the SMT training data 152.

The set of candidate pairings may be examined to select/prune the candidate pairings to select pairings that are determined to be good representations. For example, a determination may be made as to how close a query and a feed sentence are in a vector-space model. Different methods may be used to determine this distance between the query and feed sentence, such as: determining a cosine distance on term frequency-inverse document frequency (tf-idf) weighted vectors of stemmed word frequencies, and the like.

Once the SMT training data is determined, the SMT training data including the determined pairs is used to train SMT model 165 (160).

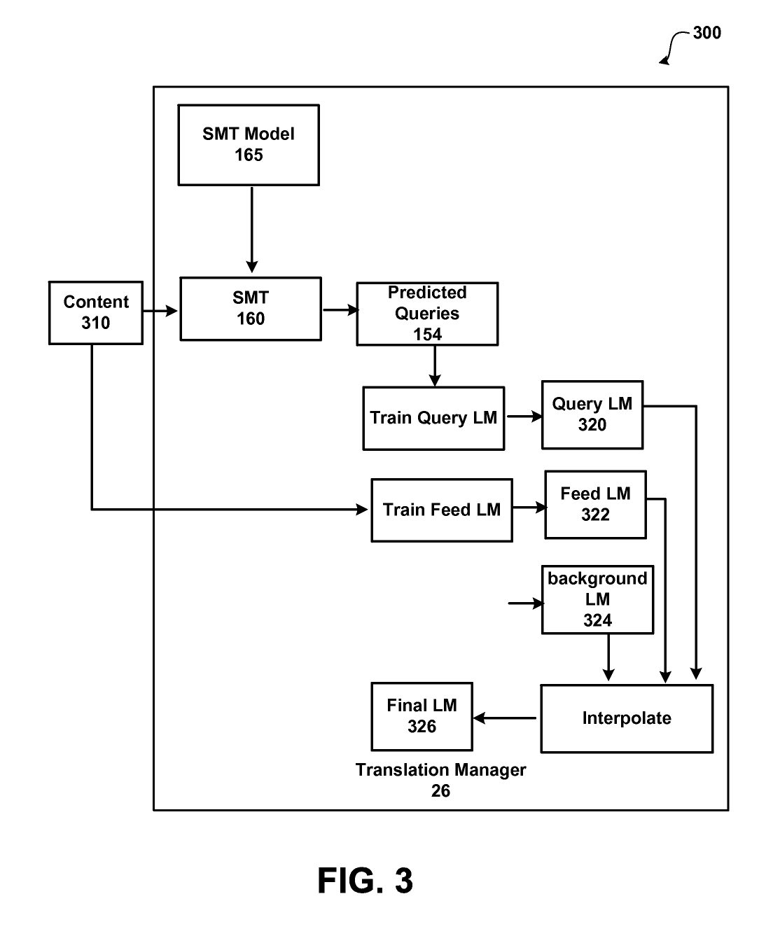

FIG. 3 illustrates using an SMT model to predict queries from received content used to train a language model. As illustrated, system 300 includes content 310, transition manager 26, SMT 160, SMT model 165, predicted queries 154, query language model (LM) 320, feed LM 322, background LM 324 and final LM 326.

SMT 160 applies the SMT model 165 to received content 310 to obtain predicted queries 154. The predicted queries are examples of queries that may be received to search for content. The predicted queries 154 are used to train a query language model 320. The received content 310 may also be used to train a feed language model 322. Instead of just using content 310 to train a language model, the predicted queries 154 determined by applying an SMT to the content is used in training a language model. The language model trained using the predicted queries may be interpolated other language modes, such as a background language model, as well as a language model trained using the feed content to create a final LM 326 for the system.

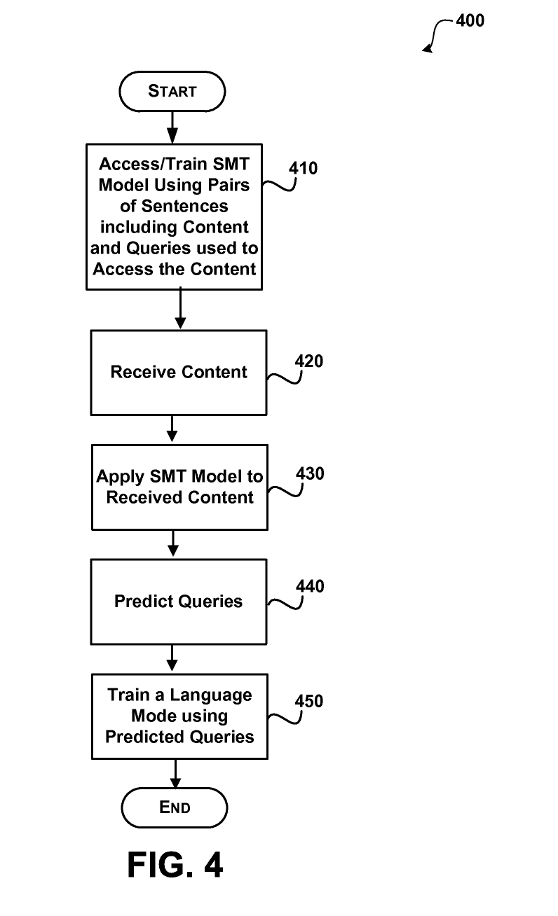

FIG. 4 illustrates an overview process for training an SMT model and using the SMT model to predict queries used in training a language model from received content. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process moves to operation 410, where an SMT model is accessed that is/was trained using pairs of sentences including content from a content source and queries previously used to access the content. The pairs used to train the SMT model used for translating content into predicted queries by an SMT may be determined using different methods. Generally, one or more representative content sources (e.g. web sites, databases, . . . ) are selected that represent content that is typical in a feed that is used in a language understanding system. For example, the content sources may be web sites from which a user may search using a voice query. Queries that have been used to access the content are associated with one or more sentences from the content sources to create candidate pairs with which to train the SMT model. Training pairs may be selected from the candidate pairs to train the SMT model. For example, some candidate pairs may be determined to not be representative.

Transitioning to operation 420, content is received. The content may come from the same content source used to train the SMT model and/or from different content sources. For example, when the SMT model is trained using a news content source, the received content source may be the same news content source and/or another news content source (e.g. a different website) and/or some other content source.

Moving to operation 430, the trained SMT model is applied to the received content. Generally, an SMT applies the SMT model to determine a translation of the received content to a predicted queries.

Flowing to operation 440, the predicted queries are received after applying the SMT model.

Moving to operation 450, the predicted queries are used to train a language model. The query language model may be interpolated other language models, such as a background language model, as well as a feed language model trained using the content used in determining the predicted queries. The language model trained using the predicted queries may then be used in a language understanding system.

The process then moves to an end operation and returns to processing other actions.

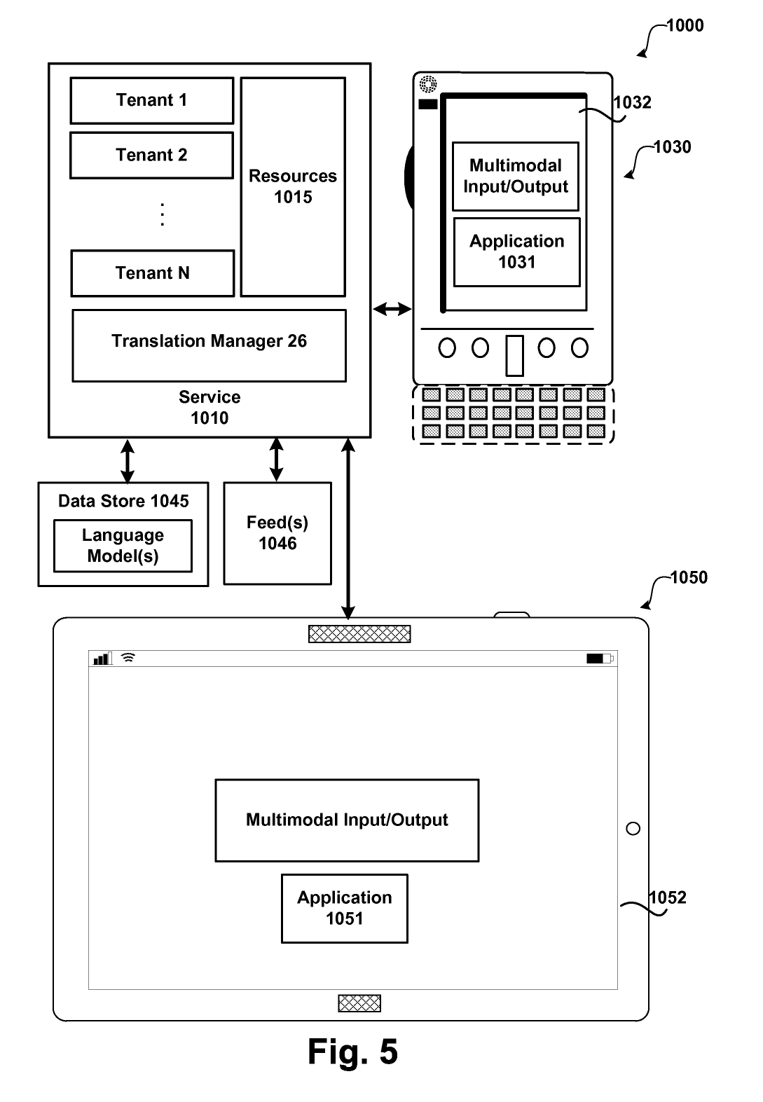

FIG. 5 illustrates an exemplary online system using a language model trained with predicted queries. As illustrated, system 1000 includes service 1010, data store 1045, touch screen input device/display 1050 (e.g. a slate) and smart phone 1030.

As illustrated, service 1010 is a cloud based and/or enterprise based service that may be configured to provide services, such as multimodal services related to various applications (e.g. searching, games, browsing, locating, productivity services (e.g. spreadsheets, documents, presentations, charts, messages, and the like)). The service may be interacted with using different types of input/output. For example, a user may use speech input, touch input, hardware based input, and the like. The service may provide speech output that combines pre-recorded speech and synthesized speech. Functionality of one or more of the services/applications provided by service 1010 may also be configured as a client/server based application.

As illustrated, service 1010 is a multi-tenant service that provides resources 1015 and services to any number of tenants (e.g. Tenants 1-N). Multi-tenant service 1010 is a cloud based service that provides resources/services 1015 to tenants subscribed to the service and maintains each tenant's data separately and protected from other tenant data.

System 1000 as illustrated comprises a touch screen input device/display 1050 (e.g. a slate/tablet device) and smart phone 1030 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 1030 and touch screen input device/display 1050 are configured with multimodal applications and each include a an application (1031, 1051).

As illustrated, touch screen input device/display 1050 and smart phone 1030 shows exemplary displays 1052/1032 showing the use of an application using multimodal input/output. Data may be stored on a device (e.g. smart phone 1030, slate 1050 and/or at some other location (e.g. network data store 1045). Data store 1054 may be used to store the central knowledge base. The applications used by the devices may be client based applications, server based applications, cloud based applications and/or some combination.

Translation manager 26 is configured to perform operations relating to using/training a language model trained with predicted queries as described herein. While manager 26 is shown within service 1010, the functionality of the manager may be included in other locations (e.g. on smart phone 1030 and/or slate device 1050).

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

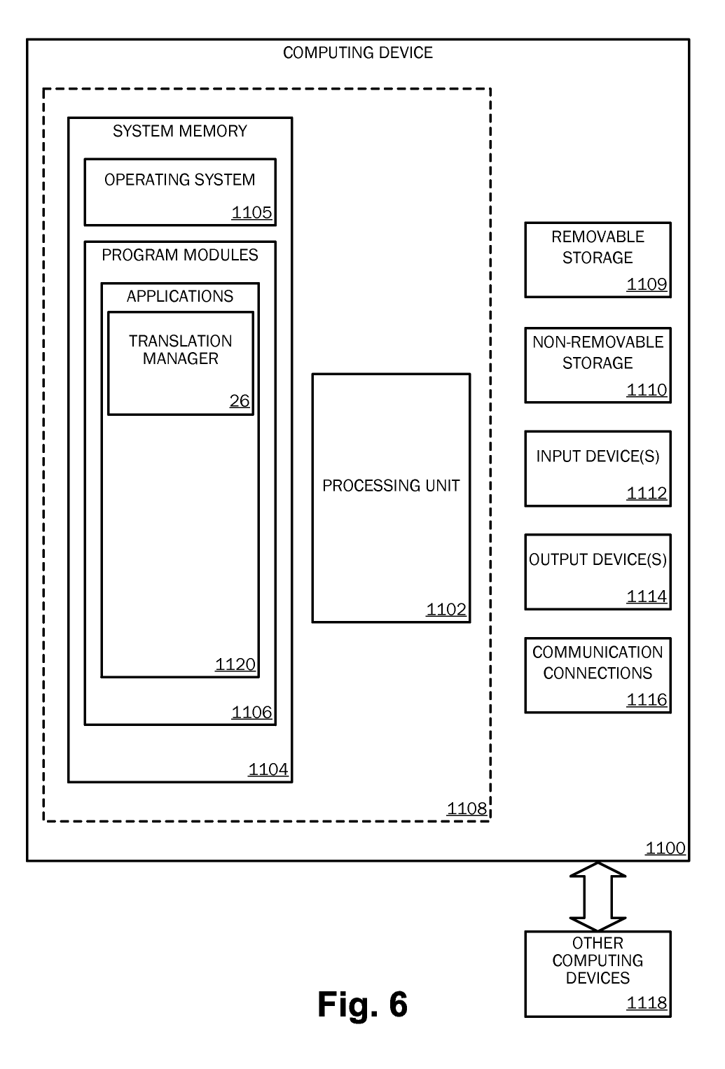

FIGS. 6-8 and the associated descriptions provide a discussion of a variety of operating environments in which embodiments of the invention may be practiced. However, the devices and systems illustrated and discussed with respect to FIGS. 6-8 are for purposes of example and illustration and are not limiting of a vast number of computing device configurations that may be utilized for practicing embodiments of the invention, described herein.

FIG. 6 is a block diagram illustrating physical components (i.e., hardware) of a computing device 1100 with which embodiments of the invention may be practiced. The computing device components described below may be suitable for the computing devices described above. In a basic configuration, the computing device 1100 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 and one or more program modules 1106 suitable for running software applications 1120 such as the translation manager 26. The operating system 1105, for example, may be suitable for controlling the operation of the computing device 1100. Furthermore, embodiments of the invention may be practiced in conjunction with a graphics library, other operating systems, or any other application program and is not limited to any particular application or system. This basic configuration is illustrated in FIG. 6 by those components within a dashed line 1108. The computing device 1100 may have additional features or functionality. For example, the computing device 1100 may also include additional data storage devices (removable and/or non-removable) such as, for example, magnetic disks, optical disks, or tape. Such additional storage is illustrated in FIG. 6 by a removable storage device 1109 and a non-removable storage device 1110.

As stated above, a number of program modules and data files may be stored in the system memory 1104. While executing on the processing unit 1102, the program modules 1106 (e.g., the translation manager 26) may perform processes including, but not limited to, one or more of the stages of the methods and processes illustrated in the figures. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the translation manager 26 may be operated via application-specific logic integrated with other components of the computing device 1100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 1100 may also have one or more input device(s) 1112 such as a keyboard, a mouse, a pen, a sound input device, a touch input device, etc. The output device(s) 1114 such as a display, speakers, a printer, etc. may also be included. The aforementioned devices are examples and others may be used. The computing device 1100 may include one or more communication connections 1116 allowing communications with other computing devices 1118. Examples of suitable communication connections 1116 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1100. Any such computer storage media may be part of the computing device 1100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

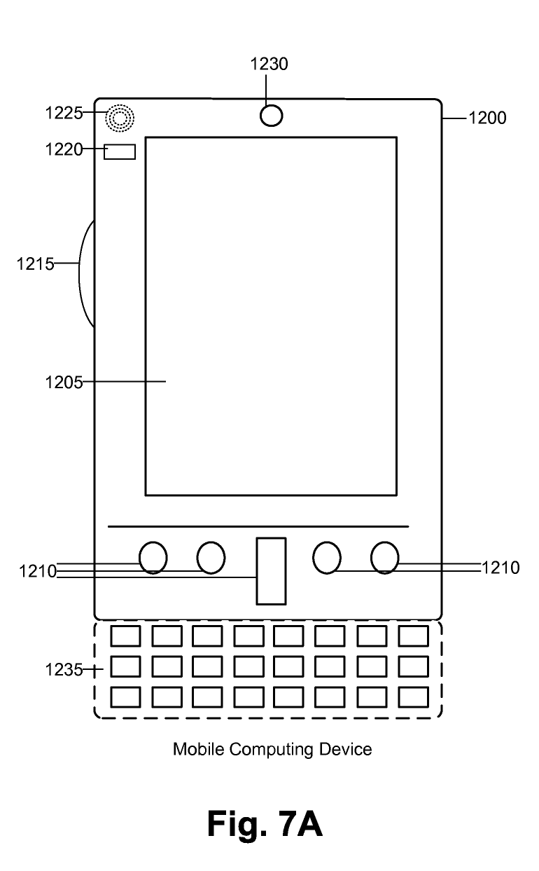

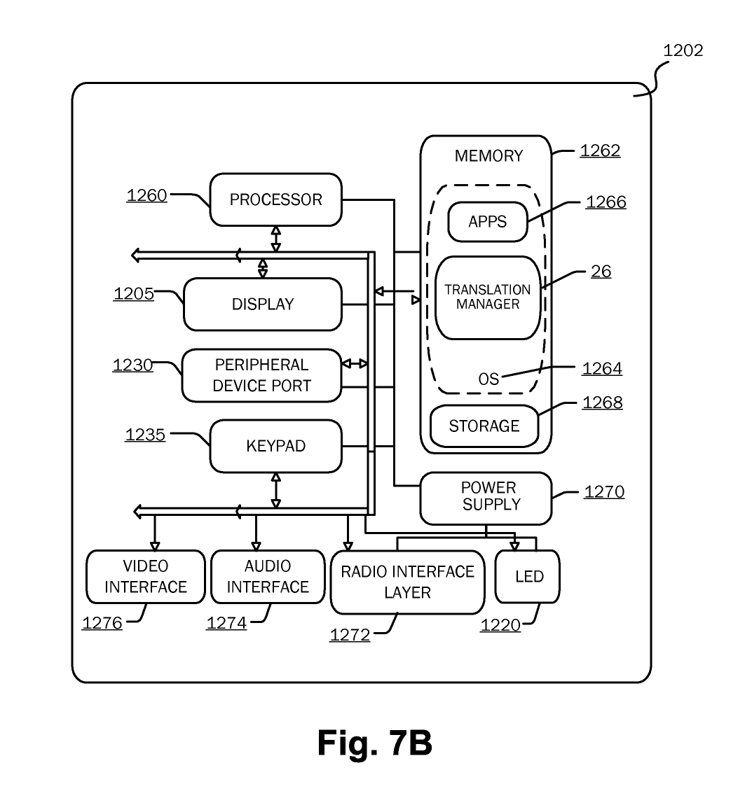

FIGS. 7A and 7B illustrate a mobile computing device 1200, for example, a mobile telephone, a smart phone, a tablet personal computer, a laptop computer, and the like, with which embodiments of the invention may be practiced. With reference to FIG. 7A, one embodiment of a mobile computing device 1200 for implementing the embodiments is illustrated. In a basic configuration, the mobile computing device 1200 is a handheld computer having both input elements and output elements. The mobile computing device 1200 typically includes a display 1205 and one or more input buttons 1210 that allow the user to enter information into the mobile computing device 1200. The display 1205 of the mobile computing device 1200 may also function as an input device (e.g., a touch screen display). If included, an optional side input element 1215 allows further user input. The side input element 1215 may be a rotary switch, a button, or any other type of manual input element. In alternative embodiments, mobile computing device 1200 may incorporate more or less input elements. For example, the display 1205 may not be a touch screen in some embodiments. In yet another alternative embodiment, the mobile computing device 1200 is a portable phone system, such as a cellular phone. The mobile computing device 1200 may also include an optional keypad 1235. Optional keypad 1235 may be a physical keypad or a “soft” keypad generated on the touch screen display. In various embodiments, the output elements include the display 1205 for showing a graphical user interface (GUI), a visual indicator 1220 (e.g., a light emitting diode), and/or an audio transducer 1225 (e.g., a speaker). In some embodiments, the mobile computing device 1200 incorporates a vibration transducer for providing the user with tactile feedback. In yet another embodiment, the mobile computing device 1200 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one embodiment of a mobile computing device. That is, the mobile computing device 1200 can incorporate a system (i.e., an architecture) 1202 to implement some embodiments. In one embodiment, the system 1202 is implemented as a “smart phone” capable of running one or more applications (e.g., browser, e-mail, calendaring, contact managers, messaging clients, games, and media clients/players). In some embodiments, the system 1202 is integrated as a computing device, such as an integrated personal digital assistant (PDA) and wireless phone.

One or more application programs 1266 may be loaded into the memory 1262 and run on or in association with the operating system 1264. Examples of the application programs include phone dialer programs, e-mail programs, personal information management (PIM) programs, word processing programs, spreadsheet programs, Internet browser programs, messaging programs, and so forth. The system 1202 also includes a non-volatile storage area 1268 within the memory 1262. The non-volatile storage area 1268 may be used to store persistent information that should not be lost if the system 1202 is powered down. The application programs 1266 may use and store information in the non-volatile storage area 1268, such as e-mail or other messages used by an e-mail application, and the like. A synchronization application (not shown) also resides on the system 1202 and is programmed to interact with a corresponding synchronization application resident on a host computer to keep the information stored in the non-volatile storage area 1268 synchronized with corresponding information stored at the host computer. As should be appreciated, other applications may be loaded into the memory 1262 and run on the mobile computing device 1200, including the translation manager 26 as described herein.

The system 1202 has a power supply 1270, which may be implemented as one or more batteries. The power supply 1270 might further include an external power source, such as an AC adapter or a powered docking cradle that supplements or recharges the batteries.

The system 1202 may also include a radio 1272 that performs the function of transmitting and receiving radio frequency communications. The radio 1272 facilitates wireless connectivity between the system 1202 and the “outside world,” via a communications carrier or service provider. Transmissions to and from the radio 1272 are conducted under control of the operating system 1264. In other words, communications received by the radio 1272 may be disseminated to the application programs 1266 via the operating system 1264, and vice versa.

The visual indicator 1220 may be used to provide visual notifications, and/or an audio interface 1274 may be used for producing audible notifications via the audio transducer 1225. In the illustrated embodiment, the visual indicator 1220 is a light emitting diode (LED) and the audio transducer 1225 is a speaker. These devices may be directly coupled to the power supply 1270 so that when activated, they remain on for a duration dictated by the notification mechanism even though the processor 1260 and other components might shut down for conserving battery power. The LED may be programmed to remain on indefinitely until the user takes action to indicate the powered-on status of the device. The audio interface 1274 is used to provide audible signals to and receive audible signals from the user. For example, in addition to being coupled to the audio transducer 1225, the audio interface 1274 may also be coupled to a microphone to receive audible input, such as to facilitate a telephone conversation. In accordance with embodiments of the present invention, the microphone may also serve as an audio sensor to facilitate control of notifications, as will be described below. The system 1202 may further include a video interface 1276 that enables an operation of an on-board camera 1230 to record still images, video stream, and the like.

A mobile computing device 1200 implementing the system 1202 may have additional features or functionality. For example, the mobile computing device 1200 may also include additional data storage devices (removable and/or non-removable) such as, magnetic disks, optical disks, or tape. Such additional storage is illustrated in FIG. 7B by the non-volatile storage area 1268.

Data/information generated or captured by the mobile computing device 1200 and stored via the system 1202 may be stored locally on the mobile computing device 1200, as described above, or the data may be stored on any number of storage media that may be accessed by the device via the radio 1272 or via a wired connection between the mobile computing device 1200 and a separate computing device associated with the mobile computing device 1200, for example, a server computer in a distributed computing network, such as the Internet. As should be appreciated such data/information may be accessed via the mobile computing device 1200 via the radio 1272 or via a distributed computing network. Similarly, such data/information may be readily transferred between computing devices for storage and use according to well-known data/information transfer and storage means, including electronic mail and collaborative data/information sharing systems.

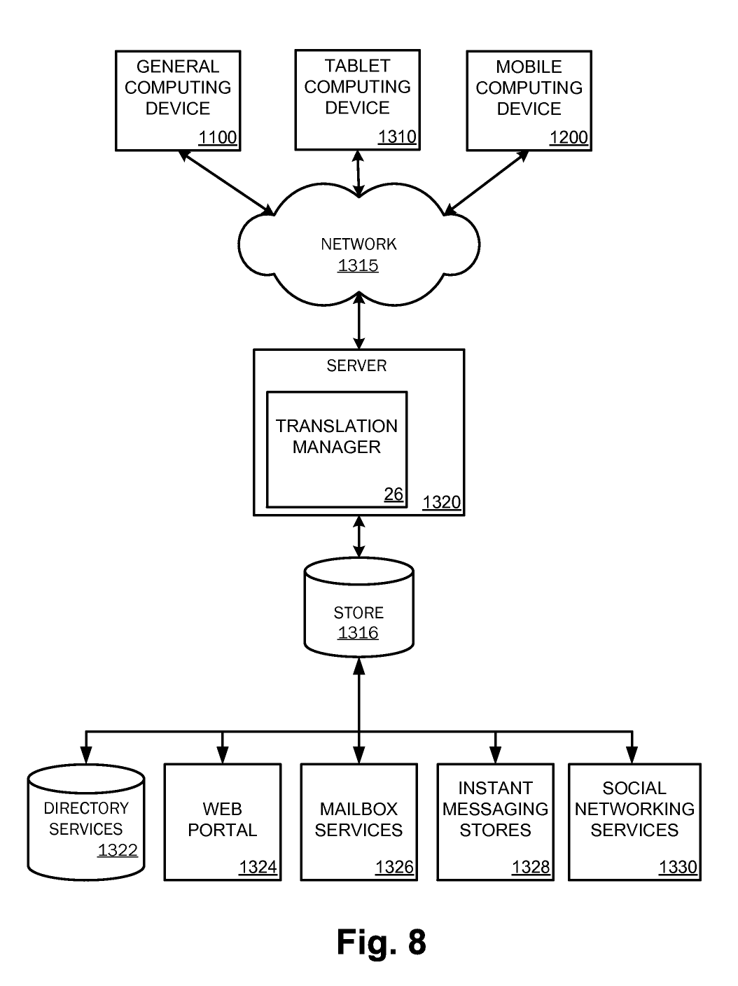

FIG. 8 illustrates an embodiment of an architecture of a system for training an SMT model that is used to predict queries used in training a language model, as described above. Content developed, interacted with, or edited in association with the translation manager 26 may be stored in different communication channels or other storage types. For example, various documents may be stored using a directory service 1322, a web portal 1324, a mailbox service 1326, an instant messaging store 1328, or a social networking site 1330. The translation manager 26 may use any of these types of systems or the like for enabling data utilization, as described herein. A server 1320 may provide the translation manager 26 to clients. As one example, the server 1320 may be a web server providing the translation manager 26 over the web. The server 1320 may provide the translation manager 26 over the web to clients through a network 1315. By way of example, the client computing device may be implemented as the computing device 1100 and embodied in a personal computer, a tablet computing device 1310 and/or a mobile computing device 1200 (e.g., a smart phone). Any of these embodiments of the client computing device 1100, 1310, 1200 may obtain content from the store 1316.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method for training a language model, comprising:
accessing a statistical machine translation (SMT) model trained using pairs that each include a sentence obtained from a content source and a query previously used to access content associated with the sentence;
receiving content from a content source;
applying the SMT model to the content to determine predicted queries; and
training a language model using the predicted queries.

2. The method of claim 1, further comprising accessing a click graph and using the click graph to assist in determining the pairs.

3. The method of claim 1, further comprising: determining seed web sites using a click graph; obtaining sentences for the pairs using results obtained by performing a search using the seed web sites.

4. The method of claim 3, reducing a number of the pairs using a determination on how close a query and a sentence within the obtained sentences are within a vector-space model.

5. The method of claim 1, further comprising determining the sentence in each pair used to train the SMT model using at least one of: a story title; at least one sentence obtained from the content; and a summary determined from results returned by a search engine.

6. The method of claim 1, wherein the SMT model is trained before receiving the content from the content source.

7. The method of claim 1, wherein training the language model comprises training a query language model and interpolating the query language model with a background language model to create the language model.

8. The method of claim 1, further comprising training a feed language model using the received content and interpolating the feed language model with a background language model to create the language model.

9. The method of claim 1, wherein training the language model comprises interpolating a background language model, a feed language model trained using the received content and a query language model trained using the predicted queries.

10. A computer-readable medium storing computer-executable instructions for training a query language model, comprising:
accessing a statistical machine translation (SMT) model trained using pairs that each include a sentence obtained from a content source and a query previously used to access content associated with the sentence;
receiving content from a content source;
applying the SMT model to the content to determine predicted queries; and
training a query language model using the predicted queries.

11. The computer-readable medium of claim 10, further comprising accessing a click graph and using the click graph to assist in determining the pairs.

12. The computer-readable medium of claim 10, further comprising: determining seed web sites using a click graph; obtaining sentences for the pairs using results obtained by performing a search using the seed web sites.

13. The computer-readable medium of claim 12, reducing a number of the pairs using a determination on how close a query and a sentence within the obtained sentences are within a vector-space model.

14. The computer-readable medium of claim 10, further comprising determining the sentence in each pair used to train the SMT model using at least one of: a story title; at least one sentence obtained from the content; and a summary determined from results returned by a search engine.

15. The computer-readable medium of claim 10, further comprising interpolating the query language model with a background language model.

16. The computer-readable medium of claim 10, further comprising training a feed language model using the received content and interpolating the feed language model with the query language model and a background language model.

17. A system or extracting natural language examples for training a query language model, comprising:
a processor and memory;
an operating environment executing using the processor; and
a translation manager that is configured to perform actions comprising:
accessing a statistical machine translation (SMT) model trained using pairs that each include a sentence obtained from a content source and a query previously used to access content associated with the sentence;
receiving content from a content source;
applying the SMT model to the content to determine predicted queries;
training a query language model using the predicted queries; and
interpolating the query language model with a background model.

18. The system of claim 17, further comprising accessing a click graph and using the click graph to assist in determining the pairs.

19. The system of claim 17, further comprising: determining seed web sites using a click graph; obtaining sentences for the pairs using results obtained by performing a search using the seed web sites.

20. The system of claim 17, further comprising training a feed language model using the received content and interpolating the feed language model with the query language model and a background language model.
